(19) United States
(12) Patent Application Publication
(10) Pub. No.: US 2016/0091116 A1
(43) Pub. Date: Mar. 31, 2016

(54) CABLE MANAGEMENT

(71) Applicants: Michael Shoecraft, San Jose, CA (US); Nicholas Barton, Richmond, CA (US)

(72) Inventors: Michael Shoecraft, San Jose, CA (US); Nicholas Barton, Richmond, CA (US)

(21) Appl. No.: 14/498,442

(22) Filed: Sep. 26, 2014

(51) Int. Cl. F16L 3/01; H02S 20/32; F16L 3/06; H02G 11/00

(52) U.S. Cl. CPC F16L 3/01; H02G 11/00; H02S 20/32; F16L 3/06

(57) ABSTRACT

Cable management is described. In one embodiment, an apparatus for cable management includes three cable support members coupled together and extending in a substantially same direction. The three cable support members include two outer members and an inner member between the two outer members. At least the two outer members each have a surface along their length substantially in a same plane. The three cable support members are spaced to constrain a cable disposed over the surface of the two outer members and under the inner member. According to one embodiment, the three cable support members are cylindrical pins. In one embodiment, the three cable support members are sections of a stiff bent wire. According to one embodiment, each of the three cable support members are sheet metal sections, wherein edges of the sheet metal sections are rounded.

### TECHNICAL FIELD

Embodiments of the present disclosure are in the field of wire or cable management, and in particular, in the field of cable management for systems with moving parts, such as photovoltaic (PV) systems with tracking mechanisms.

### BACKGROUND

“Cable management” typically refers to techniques to aid in the management of cables, and may include, for example, securing, routing, and/or organizing cables. Cable management is important in many fields such as information technology (IT) (e.g., for network cable management), power distribution (e.g., for PV systems or other power applications), and virtually any other field involving cables. A “cable” may be, or include, one or more wires (e.g., wires used to transmit power and/or data), and typically includes an outer insulating material. A “wire” is typically a flexible strand or rod of conducting material. Cables may be found in a variety of configurations and sizes to suit different applications.

A variety of cable management devices exist on the market, each with their own drawbacks. For example, some cable management solutions do not prevent the movement of cables, which can be problematic for some applications (e.g., systems involving moving parts). Cable management solutions that do not prevent the movement of cables may result in complications such as over-heating, excessive thermal expansion, and damage to the cables or surroundings due to cable movement. Other cable management solutions prevent movement of cables, but have other drawbacks such as sharp parts or edges that can damage cables, or limited cable-holding capacity.

### BRIEF DESCRIPTION OF THE DRAWINGS

FIG. 1 is a dimetric view of a cable management device including pins, in accordance with an embodiment of the present disclosure.

FIG. 2 is a dimetric view of the cable management device of FIG. 1 constraining a plurality of cables along their axes, in accordance with an embodiment of the present disclosure.

FIG. 3 is a top view of the cable management device of FIG. 1, in accordance with an embodiment of the present disclosure.

FIG. 4 is a side view of the cable management device of FIG. 1, in accordance with an embodiment of the present disclosure.

FIG. 5 is a dimetric view of a wire-form cable management device, in accordance with an embodiment of the present disclosure.

FIG. 6 is a dimetric view of the cable management device of FIG. 5 constraining a plurality of cables along their axes, in accordance with an embodiment of the present disclosure.

FIG. 7 is a top view of the cable management device of FIG. 5, in accordance with an embodiment of the present disclosure.

FIG. 8 is a side view of the cable management device of FIG. 5, in accordance with an embodiment of the present disclosure.

FIG. 9 is a dimetric view of a cable management device with sheet metal sections, in accordance with an embodiment of the present disclosure.

FIG. 10 is a dimetric view of the cable management device of FIG. 9 constraining a plurality of cables along their axes, in accordance with an embodiment of the present disclosure.

FIG. 11 is a top view of the cable management device of FIG. 9, in accordance with an embodiment of the present disclosure.

FIG. 12 is a side view of the cable management device of FIG. 9 as viewed from side A, in accordance with an embodiment of the present disclosure.

FIG. 13 is a side view of the cable management device of FIG. 9 as viewed from side B, in accordance with an embodiment of the present disclosure.

FIG. 14 is a dimetric view of a cable management device, in accordance with an embodiment of the present disclosure.

FIG. 15 is a dimetric view of the cable management device of FIG. 14 constraining a plurality of cables along their axes, in accordance with an embodiment of the present disclosure.

FIG. 16 is a top view of the cable management device of FIG. 14, in accordance with an embodiment of the present disclosure.

FIG. 17 is a side view of the cable management device of FIG. 14 as viewed from side A, in accordance with an embodiment of the present disclosure.

FIG. 18 is a side view of the cable management device of FIG. 14 as viewed from side B, in accordance with an embodiment of the present disclosure.

FIG. 19 is a dimetric view of a cable management device, in accordance with an embodiment of the present disclosure.

FIG. 20 is a dimetric view of the cable management device of FIG. 19 constraining a plurality of cables along their axes, in accordance with an embodiment of the present disclosure.

FIG. 21 is a top view of the cable management device of FIG. 19, in accordance with an embodiment of the present disclosure.

FIG. 22 is a side view of the cable management device of FIG. 19, in accordance with an embodiment of the present disclosure.

FIG. 23 is a dimetric view of a portion of a system including a photovoltaic (PV) module support and a cable management device, in accordance with an embodiment of the present disclosure.

FIG. 24 is a dimetric view of the system of claim 23 including a plurality of cables constrained in the cable management device, in accordance with an embodiment of the present disclosure.

FIGS. 25A and 25B are cross-sectional diagrams of a cable management device illustrating spacing between parts, in accordance with an embodiment of the present disclosure.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary, or the following detailed description.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps.

“Configured To.” Various units or components may be described or claimed as “configured to” perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. §112, sixth paragraph, for that unit/component.

“First,” “Second,” etc. As used herein, these terms are used as labels for nouns that they precede, and do not imply any type of ordering (e.g., spatial, temporal, logical, etc.). For example, reference to a “first” solar cell does not necessarily imply that this solar cell is the first solar cell in a sequence; instead the term “first” is used to differentiate this solar cell from another solar cell (e.g., a “second” solar cell).

“Coupled.” The following description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

Cable management devices and systems are described herein. In the following description, numerous specific details are set forth, such as specific applications for cable management devices, in order to provide a thorough understanding of embodiments of the present disclosure. It will be apparent to one skilled in the art that embodiments of the present disclosure may be practiced without these specific details. For example, some embodiments herein refer to photovoltaic (PV) module systems including cable management devices. However, the cable management techniques described herein may apply to other applications (e.g., server rooms, or other applications). In other instances, well-known fabrication techniques, such as wire forming and pin welding, are not described in detail in order to not unnecessarily obscure embodiments of the present disclosure. Furthermore, it is to be understood that the various embodiments shown in the figures are illustrative representations and are not necessarily drawn to scale.

As mentioned briefly above, existing cable management solutions tend to be deficient in one or more respect. Many cable management devices are formed from injection molded plastic and have a short life span. Other cable management devices are formed from metal, and therefore typically have a longer life span, are more reliable, and less fragile. Typical metal cable management devices include metal straps, clips, or zip ties. However, such devices have thin or sharp edges that create stress concentrations on non-metal clad wiring and can quickly cut through insulation. Cable management devices that damage cables can be especially problematic for cables used to deliver power, such as cables used in PV systems. For example, when a PV cable's insulation is damaged, there is potential for a ground fault. If the faulting component is not properly bonded to the system, then a dangerously high voltage floating lead may exist on the structure.

Another type of cable management device is a cable trough or conduit. Cable troughs and conduits have limitations in that they typically require large amounts of material to hold all the cables (e.g., material for a lid). Additionally, cable troughs or conduits typically do not prevent cable movement within the trough or conduit, which can result in excessive heating and thermal expansion, as mentioned above. Furthermore, loose cables may rattle around and damage parts of the systems, such as a junction box in a PV system or the cable insulation.

Another drawback of typical cable management solutions is the inclusion of small additional components, such as components that are snapped or screwed into a support structure during installation or cable routing. Such small components typically require small holes for mounting. Small holes in a cable management device can be problematic if the device is to be galvanized. For example, galvanization may close or “seal up” such small holes. However, a non-galvanized device may experience increased corrosion in the field. As an alternative to a device having small holes for mounting, self-tapping or self-drilling screws may be employed. However, self-tapping/drilling screws typically results in significantly increased installation time and require additional installation equipment (e.g., a drill). Other small components such as cable routing fasteners and clips may be easily lost and are difficult to manage in large quantities.

Another type of cable management device employs spring tension over a cable to clamp the cable similar to a clothespin on a line. Although such devices may be effective at limiting cable movement, a very limited number of cables may be held by each clip. Additionally, if any one of the cables going through such a clip are of a larger diameter, none of the other cables in the clip will be retained with the pressure of the clip.

Disclosed herein are apparatuses (e.g., devices) and systems for cable management. In one embodiment, an apparatus includes three cable support members coupled together and extending in a substantially same direction. The three cable support members include two outer members and an inner member between the two outer members. At least the two outer members each have a surface along their length substantially in a same plane. Additionally, the three cable support members are spaced to constrain a cable disposed over the surface of the two outer members and under the inner member.

Also disclosed herein are systems including a cable management apparatus. In one embodiment, a system includes a PV module support to support one or more PV modules over an installation surface. The system also includes a cable management apparatus coupled with the PV module support. The cable management apparatus includes three cable support members coupled together and extending in substantially the same direction. The three cable support members include two outer members and an inner member between the two outer members. At least the two outer members each have a surface along their length in substantially the same plane, and the three cable support members are spaced to constrain a cable disposed over the surface of the two outer members and under the inner member.

According to one embodiment, the cable management apparatus of the system includes three pins coupled with and extending from the solar module support in a substantially same direction. The three pins include two outer pins and a middle pin between the two outer pins, and the three pins are spaced to constrain a cable disposed over the two outer pins and under the middle pin.

Thus, embodiments include cable management devices that enable holding and constraining many cables without damaging the cables due to sharp edges and/or areas of excessive stress. The cables going through the cable management device experience some deformation, and thus will have a corresponding friction against the structure, according to embodiments. Thus, embodiments can accommodate a range of cable diameters while still providing a frictional restraint on each cable.

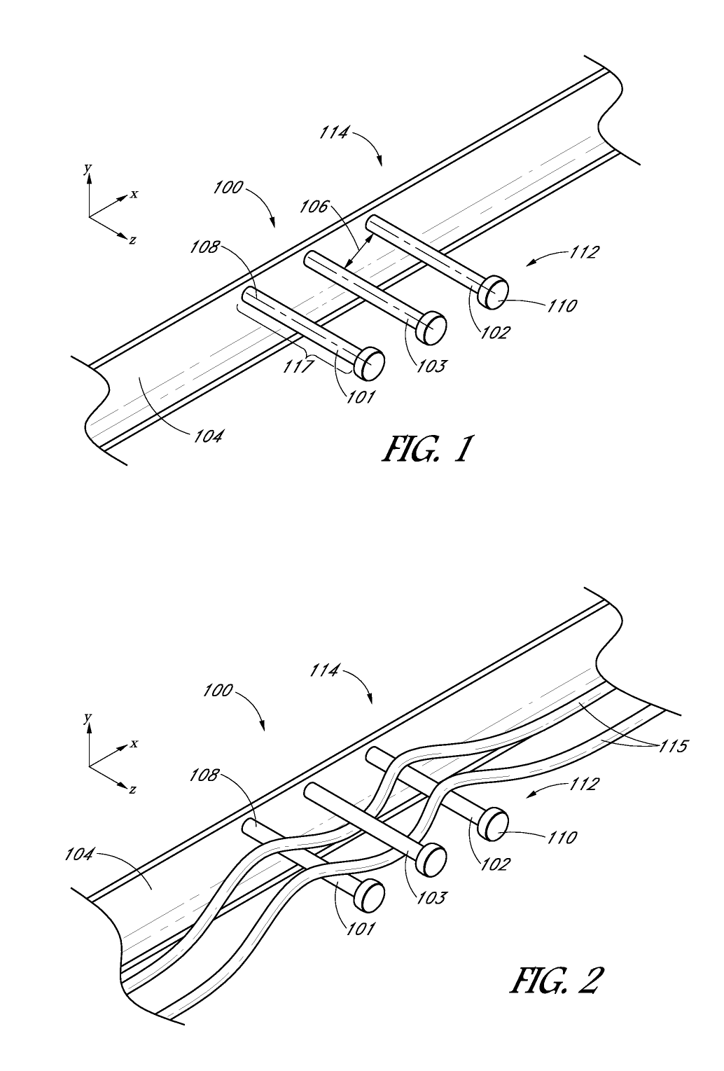

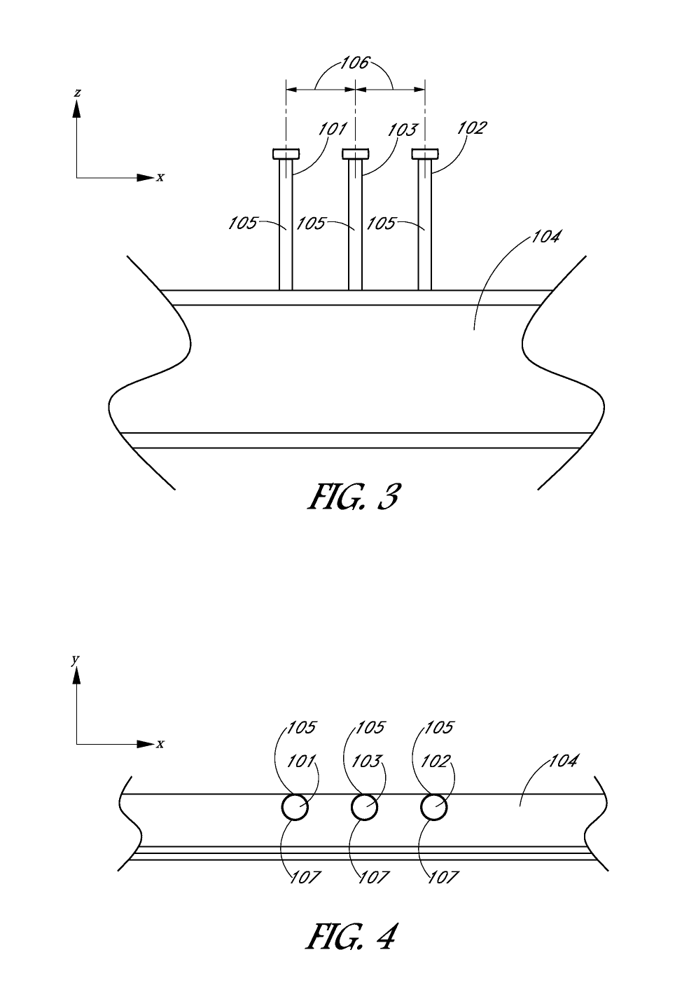

Turning to the figures, FIGS. 1-4 illustrate different views of a cable management device 100 that includes pins, in accordance with an embodiment of the present disclosure. FIG. 1 is a dimetric view of the cable management device 100. The cable management device 100 includes three cable support members 101, 102, and 103 coupled together and extending in a substantially same direction (along the z-axis in the example illustrated in FIG. 1). In one embodiment, the cable support members 101, 102, and 103 are substantially parallel to one another. The three cable support members 101, 102, and 103 include two outer members 101 and 102 and an inner member 103 between the two outer members 101 and 102. At least the two outer members 101 and 102 each have a surface along their length substantially in a same plane (e.g., the outer members are planar). In the example illustrated in FIG. 1, the inner member 103 also has a corresponding surface along its length in the same plane as the two outer members 101 and 102. In one such embodiment, the entire device could be considered to be planar. FIG. 3, which is a top view of the cable management device 100, shows an example of surfaces (in this case, top surfaces 105) of the cable support members 101, 102, and 103 that are in the same plane. The bottom surfaces of the cable support members 101, 102, and 103 may also, or alternatively, be in the same plane as each other. In other embodiments, the inner member 103 may be offset from the two outer members 101 and 102. For example, the inner member 103 may be offset relative to the outer members 101 and 102 to accommodate large or inflexible cables (e.g., a positive offset along the y-axis in the example in FIG. 1). In another example, the inner member 103 may be offset to apply greater pressure and/or distort constrained cables to a greater extent (e.g., a negative offset along the y-axis in the example of FIG. 1).

The three cable support members 101, 102, and 103 are spaced to constrain one or more cables. A cable is “constrained” along its axis if the cable's movement is limited or prevented in response to a force exerted on the cable. For example, a constrained cable may experience no or insignificant movement in response to a pulling force exerted on the cable. FIG. 2 is a dimetric view of the cable management device of FIG. 1 constraining a plurality of cables 115 along their axes. The cables 115 are disposed over the surface of the two outer members 101 and 102 and under the inner member 103. For example, the three cable support members 101, 102, and 103 are spaced to constrain a cable disposed over the top surface 105 (see FIG. 4) of the two outer members 101 and 102 and under the bottom surface 107 (see FIG. 4) of the inner member 103. The spacing of the cable support members 101, 102, and 103 enables a cable to be constrained at three points along its axis due to friction created between the cable and the three cable support members 101, 102, and 103 at those points. Thus, “spaced to constrain one or more cables” refers to the spacing amongst the cable support members 101, 102, and 103 to create sufficient friction between the cable(s) 115 and cable support members 101, 102, and 103 to substantially limit movement of the cables 115. In particular, the distance 106 (see FIGS. 1 and 3) may be in a range to accommodate the constrained cable diameter while creating the desired friction to constrain the cable(s). In one embodiment, the configuration keeps the constrained cables flat (e.g., only one layer deep), which can enable easy identification of the cables, in contrast to existing solutions in which cables may be difficult to identify in a bundle or tray.

The spacing between the three cable support members 101, 102, and 103 typically depends upon the desired cable diameter(s) to be restrained, and the diameter(s) of the cable support members 101, 102, and 103. In one embodiment, the three cable support members 101, 102, and 103 are equally spaced. However, other embodiments may include non-equal spacing of the three cable support members 101, 102, and 103. One example where non-equal spacing might be used is where one of the outer support members is offset from the other support members, in which case the spacing between the offset support member and the other support members may be greater than the spacing between the support members that are in the same plane.

A specific example of cable support member spacing is illustrated in FIGS. 25A and 25B. FIGS. 25A and 25B are cross-sectional diagrams of a cable management device including pins, such as the device 100 of FIG. 1. However, the general spacing principals shown in FIGS. 25A and 25B may apply to other embodiments as well.

Turning to FIG. 25A, a cable 2515 is held by three cable support members 2501, 2502, and 2503. The illustrated cable support members 2501, 2502, and 2503 are separated by a distance of x. The cable 2515 bends (e.g., experiences some distortion) to conform to the three support members 2501, 2502, and 2503. According to one embodiment, the spacing, x, is in a predetermined range to enable sufficient force to prevent the cable 2515 from moving. The predetermined range is dependent upon the bend radius, R_{bend}, the cable diameter, D_{cable}, and the cable support member diameter, dₛᵤₚₚ. The bend radius, R_{bend}, is determined based on a mid-point 2516 of the cable 2515. FIG. 25B illustrates a close-up view of these parameters with respect to the cable support members 2502 and 2503. In one embodiment, the relationship amongst these parameters may be given by equation (1).

$${( {R}_{bend} - ( \frac{{D}_{cable} + {d}_{supp}}{2} ) )}^{2} + {x}^{2} = {( {R}_{bend} + ( \frac{{D}_{cable} + {d}_{supp}}{2} ) )}^{2} \qquad ( 1 )$$

Equation (1) may then be solved for x, as shown in equation (2):

$$x ( {R}_{bend} , {D}_{cable} , {d}_{supp} ) , = \sqrt{4 R ( \frac{{D}_{cable} + {d}_{supp}}{2} )} \qquad ( 2 )$$

The distance between cable support members can be determined to achieve the correct holding force on the cable. When cable is applied to the contour of the device (e.g., routed over and under the cable support members as illustrated in FIG. 2), the cable is forced into a curved shape whose radius is a function of the device geometry and the cable outside diameter. When the cable is forced into the prescribed shape, the elastic properties of the cable jacket (e.g., surrounding insulating material) and inner conductor(s) cause there to be a force between the cable and on three points of contact of the device. This elastic deformation contact force, as well as the small change in direction of the cable, provides enough friction to prevent the cable from moving within the device. This technique of restraining cables can enable accommodating cables of different diameters at the same, unlike existing devices for constraining cables. Thus, when the bend radius, cable diameter, and cable support member diameter are known, the distance between the three cable support members 2501, 2502, and 2503 sufficient to constrain the cable may be determined using equation (2).

Equations (1) and (2) may be modified to reflect different configurations (e.g., offset cable support members, cable support members with non-equal spacing, or other configurations described herein). Equations (1) and (2) may also be modified to consider other factors that may influence spacing of the cable support members, such as the elasticity (or rigidity) of the cable support members or the cables to be constrained. For example, a cable management device for holding a more rigid cable may need to have slightly larger spacing due to the cable's limited ability to deform. The rigidity of the cable support members depends in part on the material. Referring to the materials of the device, the cable support members may be made out of any material sufficient to create friction amongst the support members and cables to be held by the device. For example, the cable support members may be formed from metal, plastic, or another suitable material. Suitable plastics may include such as a polystyrene and/or polyphenylene oxide, including blends of such materials, such as NORYL™ or another wear and weather resistant plastic. The wire management devices described herein can also be composed of glass-filled plastics, such as glass-filled NORYL™, as well as or other polymers or copolymers, including thermoplastics like acetal. In an embodiment including metal cable support members, the device may be galvanized (e.g., via hot dip galvanization) to prevent rusting. In contrast with some existing cable management solutions with fine holes or other features, embodiments such as the device in FIG. 1, do not include very fine features that would be destroyed by galvanization.

Returning to FIG. 1, the three cable support members 101, 102, and 103 may be formed in a variety of shapes. For example, the cable support members 101, 102, and 103 depicted in FIG. 1 include cylinders that each have an axis 108 substantially in the same plane. Unlike existing cable management devices, the cylindrical support members 101, 102, and 103 lack sharp edges in the areas where the cable contacts the support members 101, 102, and 103. The lack of edges may prevent damage to cables constrained by the device due to excessive points of pressure. Additionally, the cylindrical cable support members 101, 102, and 103 can enable a symmetrical device such that the “top” surfaces 105 (see FIGS. 3 and 4) and the “bottom” surfaces 107 (see FIG. 4) of the three cable support members 101, 102, and 103 may be reversed, increasing the flexibility of configurations in which the device may be used on the field.

In the embodiment depicted in FIG. 1, the cable support members 101, 102, and 103 are formed from cylindrical pins (or round dowels). For example, the three cable support members 101, 102, and 103 depicted in FIG. 1 include pins having a cylindrical body 117 and a head 110 (which, in the illustrated embodiment is also round and has a slightly larger than the cylindrical body 117). The slightly larger head 110 may prevent cables 115 from sliding off the cable support members 101, 102, and 103 in the event of movement of the cables 115. In addition to the benefits described above with respect to cylindrical cable support members, another benefit of pin-based cable-support members includes ease of manufacture. For example, a pin welder may be used to directly weld the cable support members 101, 102, and 103 onto a desired structure. For example, in the embodiment illustrated in FIG. 1, the cable support members 101, 102, and 103 are coupled with a support member 104 (e.g., via welding with a pin welder) at a substantially perpendicular angle. Several benefits may be observed by directly attaching the cable management device 100 to an underlying structure. For example, a cable management device welded onto a support structure may not require separate tracking, assembly, or installation.

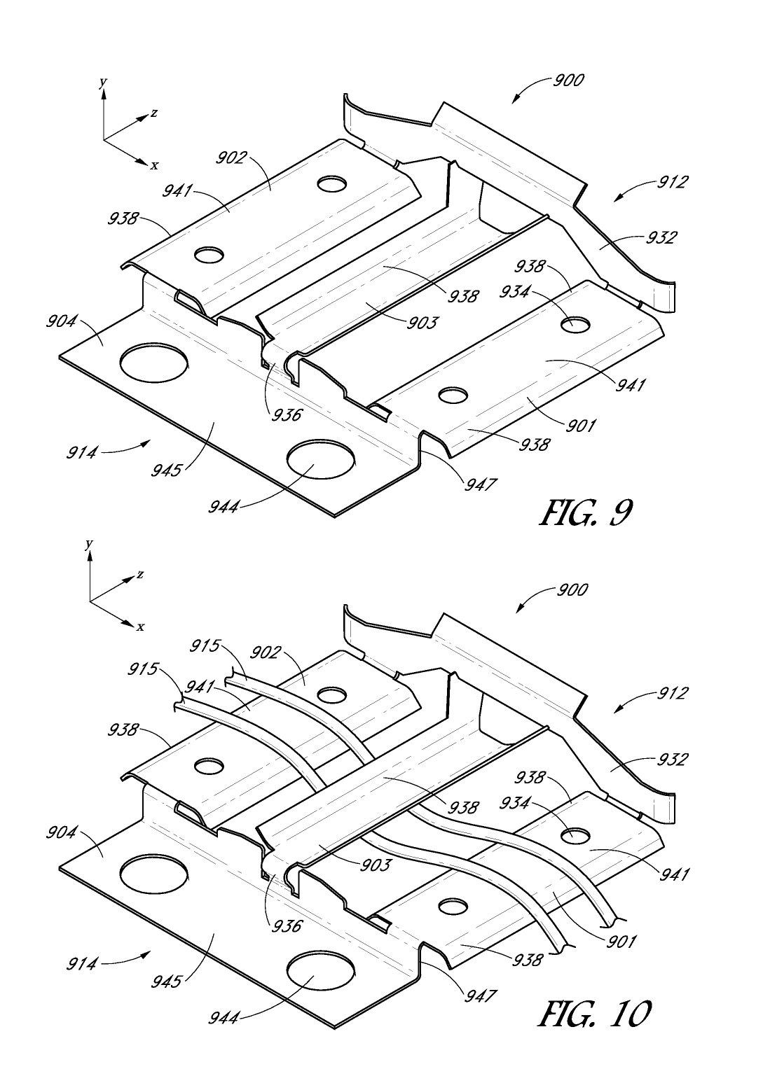

In one embodiment, each of the cable support members 101, 102, and 103 are separated (e.g., not coupled together) at one end 112, and coupled together at the opposite end 114. For example, the cable support members 101, 102, and 103, are attached at one end 114 to a supporting structure (the support member 104), but unattached to another structure on the opposite end 112, creating an “open end.” A cable management device with an open end may enable easier and faster cable routing, and may also facilitate maintenance by making it easier to access cables that need to be inspected or replaced. Other embodiment may include cable support members that are coupled together at both ends. For example, as discussed in greater detail below, the description corresponding to FIGS. 9 and 19 describe embodiments in which cable support members may be coupled together at both ends.

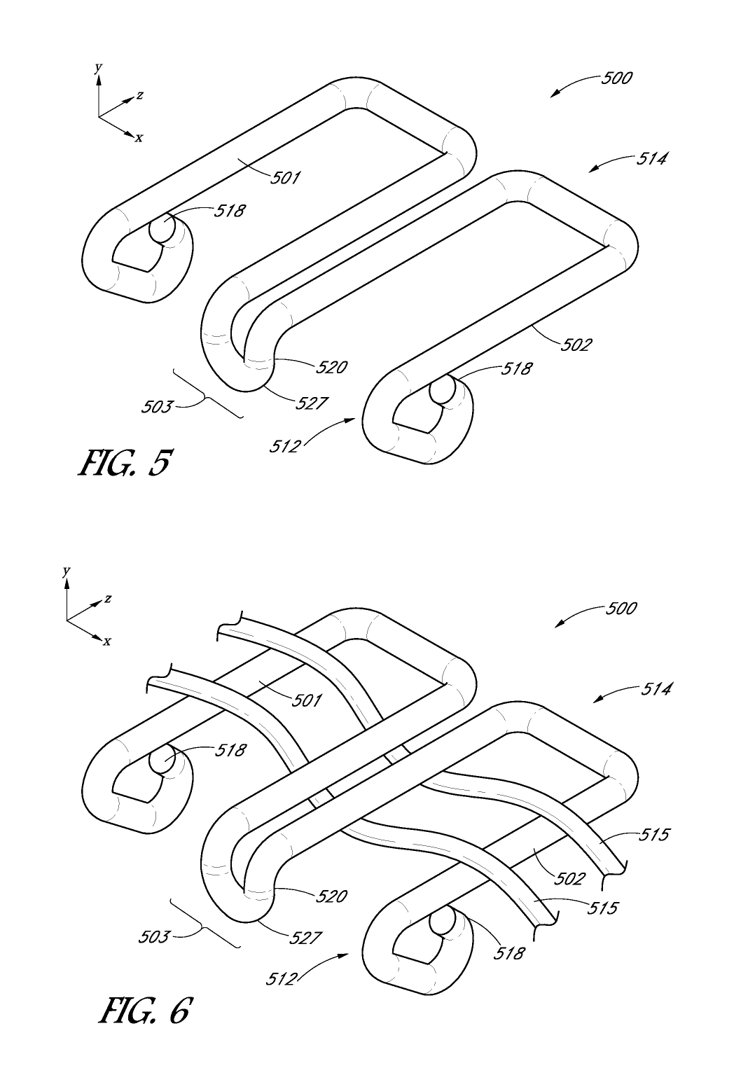

Although the above description refers to three cable support members, other embodiments may include a different number of cable support members. For example, some embodiments may include more than three cable support members (e.g., four, five, or more cable support members). FIG. 23 illustrates one such example with more than three cable support members. In other embodiments, the cable support members may have different shapes than the embodiment depicted in FIG. 1. Additionally, one or more cable support members may have a shape that differs from the other cable support members in a given device. For example, the inner cable support member 103 may have a different shape than the outer cable support members 101 and 102. Examples of cable management devices with different support members are depicted in FIGS. 5-22

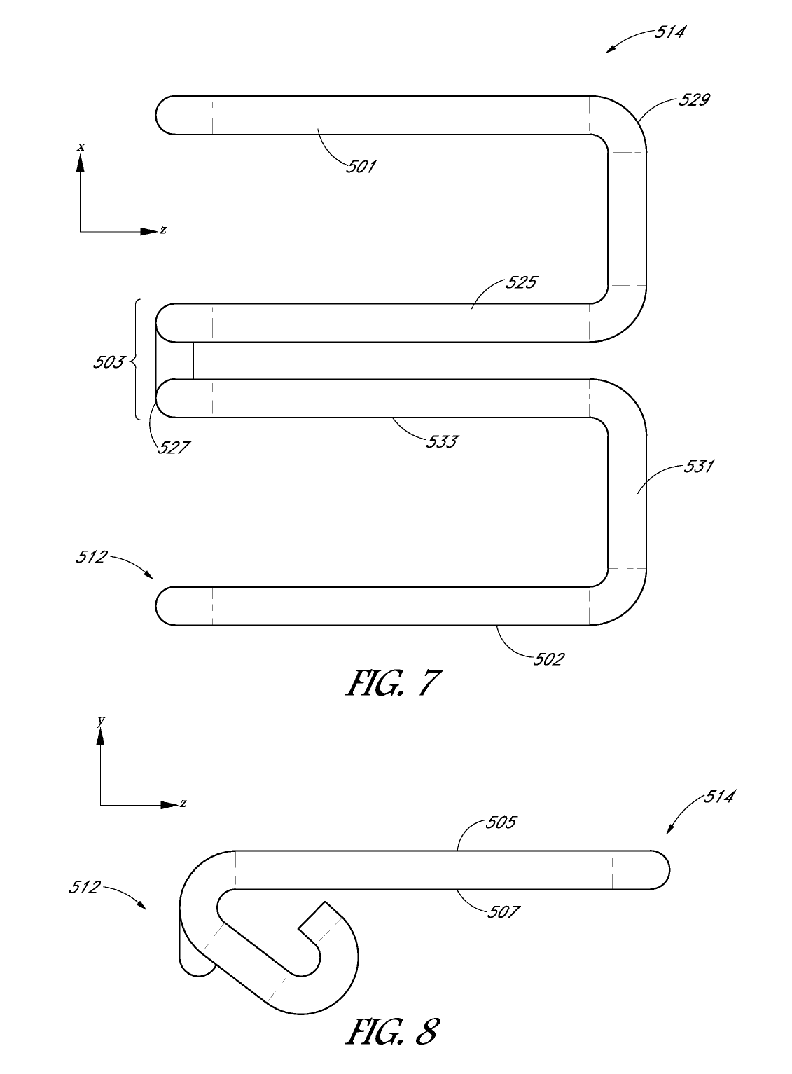

FIGS. 5-8 illustrate another cable management device, in accordance with an embodiment of the present disclosure. FIG. 5 is a dimetric view of a wire-form cable management device 500. FIG. 6 is a dimetric view of the cable management device of FIG. 5 when constraining a plurality of cables 515 along their axes. FIG. 7 is a top view of the cable management device of FIG. 5, and FIG. 8 is a side view of the cable management device of FIG. 5.

Similar to the device 100 of FIG. 1, the cable management device 500 includes three cable support members 501, 502, and 503 coupled together and extending in a substantially same direction (along the z-axis in the example illustrated in FIG. 5). The three cable support members 501, 502, and 503 include two outer members 501 and 502 and an inner member 503 between the two outer members 501 and 502. At least the two outer members 501 and 502 each have a surface along their length substantially in a same plane. In the example illustrated in FIG. 5, the inner member 503 also has a corresponding surface along its length in the same plane as the two outer members 501 and 502. The different configurations described above with respect to the device 100 of FIG. 1 may also apply to the device 500 of FIG. 5. For example, the bottom surfaces of the cable support members 501, 502, and 503 may also, or alternatively, be in the same plane as each other, or the inner member 503 may be offset from the two outer members 501 and 502.

The cable management device 500 of FIG. 5 may be “wire-form” (e.g., formed from a stiff metal wire that is bent into shape). Thus, the three cable support members 501, 502, and 503 are formed from sections of the stiff bent wire. For example, as is seen more clearly from the top view of FIG. 7, the wire has a straight section of wire that forms one of the outer members 501. The wire also includes a bend 529 and another straight section 525 of wire, which is part of the inner member 503. In the embodiment depicted in FIG. 7, the bend 529 is actually two bends separated by a straight section of wire. However, the bend could also be a continuous bend (e.g., without a straight section of wire between two distinct bends).

The wire includes another bend 527 and another straight section 533 of wire, which is another part of the inner member 503. Thus, the inner member 503 in the depicted embodiment includes a section of the wire bent into two substantially parallel sections 525 and 533. Each of the two substantially parallel sections 525 and 533 includes a support point to constrain a cable along its axis. The two sections 525 and 533 may also be parallel with the outer members 501 and 502, as illustrated in FIG. 7. The cable further includes the bend 531 and another straight section of wire that forms the outer member 502. Similar to the device 100 of FIG. 1 described above, the three cable support members 501, 502, and 503 are spaced to constrain the cables 515 disposed over the surface of the two outer members 501 and 502 and under the inner member 503. Thus, the cable is disposed over the top surface 505 (see FIG. 8) of the two outer members 501 and 502 and under the bottom surface 507 (see FIG. 8) of the inner member 503. The wire may have a round cross-section, such as in FIG. 5, or may have a different shaped cross-section. A round cross-section (or other shape with rounded edges) may have the benefit of limiting concentrated areas of pressure, thus preventing damage to the constrained cables.

In one wire-form embodiment, one or more sections of the device may include additional features that may improve the device's ability to constrain cables. For example, in addition to the three cable support members that constrain a cable along its axis, the device 500 further includes an additional bend 520 at the end 512 of the inner member 503. Thus, the bend 527 is further bent towards the cables 515 that are being constrained to form the bend 520. In one such embodiment, the bend 520 forms an additional barrier that may prevent cables from sliding out of the device 500 (e.g., in the event that the cables experience movement despite the friction created between the cable and the three cable support members 501, 502, and 503). The ends 518 of the wire are illustrated as bent under and inwards to create blunter ends, which may be desirable to prevent the device 500 from hooking on or damaging surroundings. The cable management device 500 is illustrated as separate from a support structure. However, according to embodiments, the cable management device 500 may be coupled to a support structure (e.g., via a coupling means at the end 514 of the device during the manufacturing process or in the field during installation).

As described above, the cable management device 500 may be wire-form. A wire-form device is typically inexpensive and simple to produce (e.g., using a wire-forming or wire-bending machine), and can be formed from a single piece of wire. However, embodiments having the form depicted in FIG. 5 may be manufactured via other techniques, and may be formed from different materials, as mentioned above. For example, the device 500 may be formed from plastic or another suitable material, and may include a single monolith piece or a plurality or pieces.

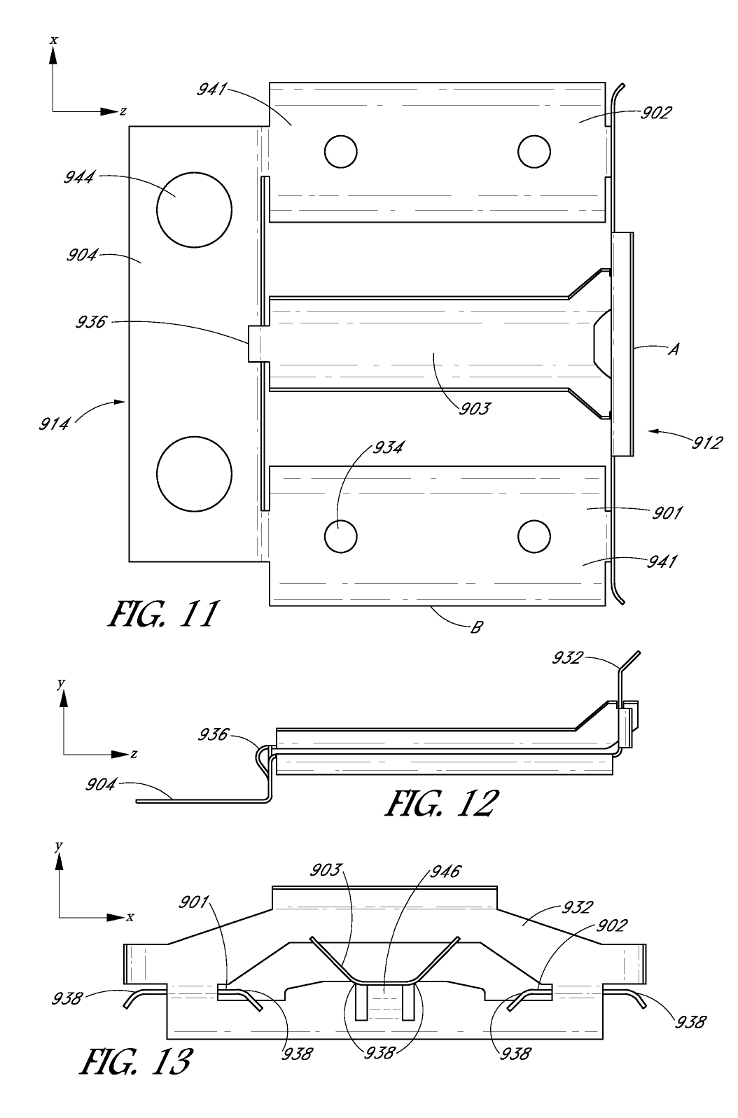

FIGS. 9-13 illustrate another cable management embodiment including sheet metal sections. FIG. 9 is a dimetric view of a cable management device 900 with cable support members 901, 902, and 903 including sheet metal sections. FIG. 10 is a dimetric view of the cable management device 900 when it is constraining cables 915. FIG. 11 is a top view of the cable management device 900. FIGS. 12 and 13 are side views of the cable management device 900. FIG. 12 illustrates a side view as viewed from side B (see FIG. 11), and FIG. 13 is a side view as viewed from side A (see FIG. 11).

Turning to FIG. 9, similar to the device 100 of FIG. 1, the cable management device 900 includes three cable support members 901, 902, and 903 coupled together. The three cable support members 901, 902, and 903 include two outer members 901 and 902 and an inner member 903 between the two outer members 901 and 902. The cable support members 901, 902, and 903 are spaced to constrain a cable disposed over the surface of the two outer members 901 and 902 and under the inner member 903. The three cable support members 901, 902, and 903 extend in a substantially the same direction when in a “closed” position, as described in more detail below. In the example illustrated in FIG. 9, the three cable support members 901, 902, and 903 extend along the z-axis when in a closed position. The two outer members each have a “top” surface 941 substantially in a same plane. The bottom surface (not visible in the Figures) of the inner member 903 may also be in the same plane when in the closed position. Thus, in one embodiment, the cable support members 901, 902 and 903 are parallel when in a closed position. In other embodiments, the bottom surface of the inner member may be in a different plane than the top surface of the two outer members 901 and 902. The different configurations described above with respect to the device 100 of FIG. 1 may also apply to the device 900 of FIG. 9. For example, the inner member 903 may be offset from the two outer members 901 and 902.

The edges 938 of the cable support members 901, 902, and 903 are rounded (e.g., not sharp). “Rounded edges” may include smooth edges, or edges having a plurality of bends at obtuse angles (e.g., to form an approximation to rounded edges). In the embodiment depicted in FIG. 9, the edges 938 include smooth edges. As mentioned above, unlike sharp edges, rounded edges may have the benefit of limiting concentrated areas of pressure, thus preventing damage to the constrained cables 915. Also in the illustrated embodiment, the outer members 901 and 902 include openings (e.g., holes) 934, which may facilitate coupling with a support structure and/or air flow.

In the illustrated embodiment, the three cable support members 901, 902, and 903 are each coupled with a support member or “spine” 904 at one end 914, and a second support member 932 at the opposite end 912. The support members 904 and 932 may be sheet metal sections or other elements with which the cable support members 901, 902, and 903 may be coupled. In the embodiment illustrated in FIG. 9, the support member 904 includes two planar sheet metal sections 945 and 947, which are at a substantially perpendicular angle relative to each other. The sheet metal section 945 includes openings (e.g., holes) 944 to facilitate coupling with another support structure (e.g., via fasteners such as bolts or other appropriate fasteners). The sheet metal section 947 is coupled with both the sheet metal section 945 and the cable support members 901, 902, and 903. The sheet metal section 947 raises the level of the cable support members 901, 902, and 903 relative to the sheet metal section 945, which enables the edges 938 of the cable support members 901, 902, and 903 to have a rounded edge without extending past the sheet metal section 945 (which in turn may facilitate attaching the device 900 to a support structure having a flat surface). The support members 904 and 932 may have a different shapes or configurations in other embodiments.

Similarly, in one embodiment, the outer members 901 and 902 are coupled with the support members 904 and 932 in a fixed position. The inner member 903 is rotatably coupled with the support member 904 at one end 914 and detachably coupled with the support member 932 at the opposite end 912. Thus, in one such embodiment, the inner member 903 can rotate or otherwise move relative to the support member 904 at the end 914 to be in an open or closed position. In an “open position,” the inner member 903 at the end 912 is rotated up and away from the support member 932 to form an opening or gap between the inner member 903 and the support member 932. In a “closed position”, the inner member 903 at the end 912 is in contact (e.g., direct contact) with the support member 932. In FIG. 9, the inner member 903 is in a closed position.

Thus, in one embodiment, the outer cable support members 901 and 902 and the support members 904 and 932 form a frame across which the inner member 903 extends when in a closed position. In the example illustrated in FIG. 9, the inner cable support member 903 is coupled with the support member 904 via a hinge 936. Thus, the inner cable support member 903 can rotate relative to the support member 904 about an axis. Other embodiments may include other mechanisms to rotatably couple the inner member 903 with the support member 904. The support member 932 may include a mechanism 946 (see FIG. 13) to secure the inner member 903 in the closed position, such as a latch or other appropriate mechanism.

FIG. 10 illustrates the cable management device 900 when it is constraining a plurality of cables 915. To introduce the cables into the device 900, the inner member 903 can be moved into the open position (e.g., rotated up and away from the support member 932 via the hinge 936). The cables may then be laid across the top surfaces 941 of the outer members 901 and 902. The inner member 903 may then be moved into a closed position (e.g., rotated down and towards the support member 932 via the hinge 936 and/or closed via a latch or other coupling mechanism 946). The action of moving the inner member 903 into a closed position applies pressure to the cables 915, and thus creates friction between the cables 915 and the cable support members 901, 902, and 903. The friction substantially limits movement of the cables 915 when the inner member 903 is in the closed position.

Thus, a cable management device with three cable support members may include sheet metal sections, such as described above with respect to FIGS. 9-13. The cable management device 900 may provide a device that can constrain cables without damaging the cables due to sharp edges. Additionally, the ability of the device 900 to be opened according to one embodiment enables easy addition and removal of cables from the device. In some embodiments, a cable management device with sheet metal sections may have some drawbacks such as high tooling expense due to the formation of complex bends. Additionally, some sheet-metal based embodiments may additionally have some sharp edges, which have the potential to damage cables.

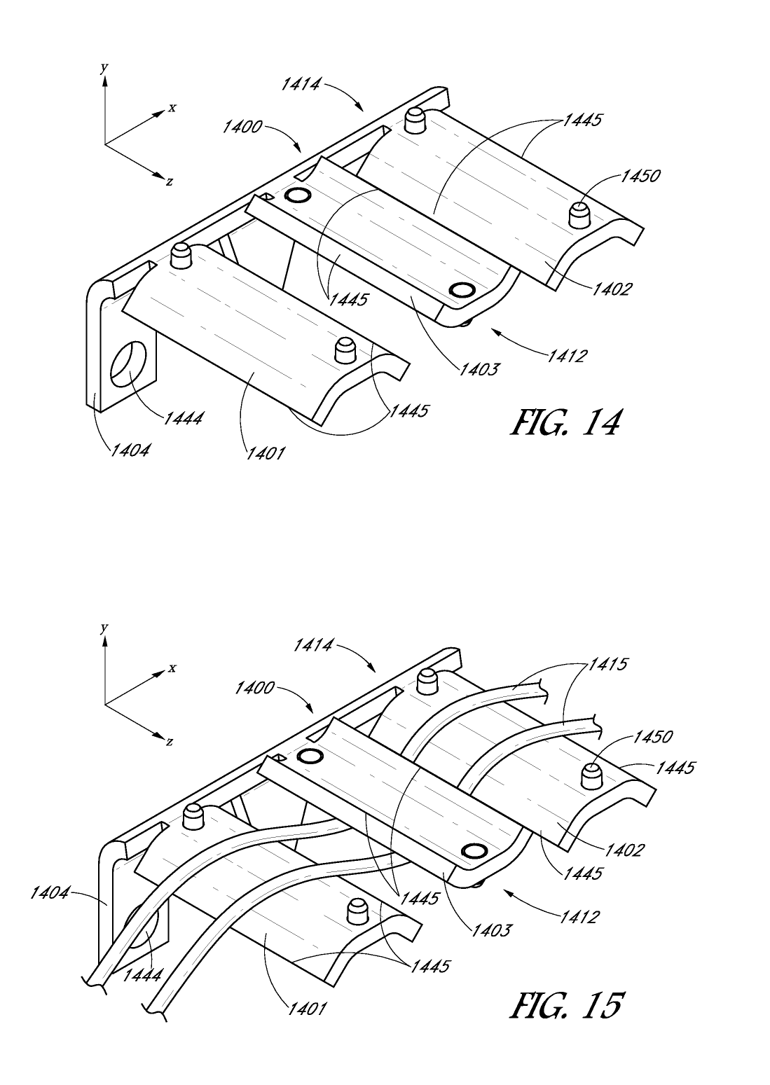

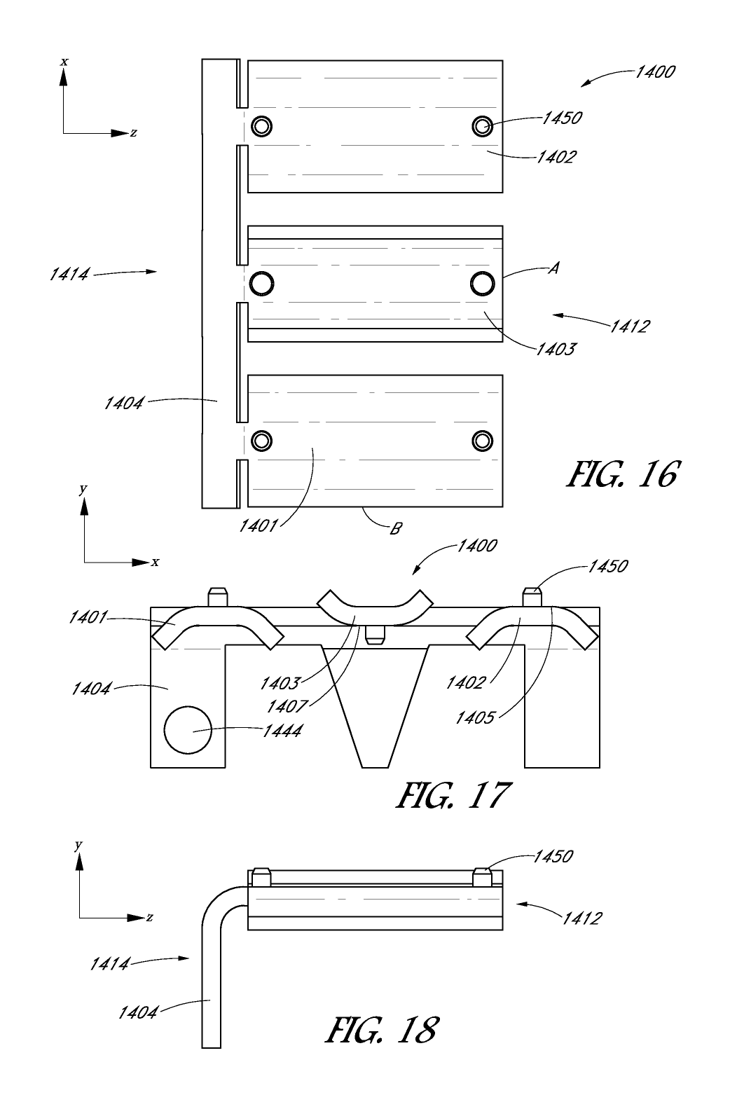

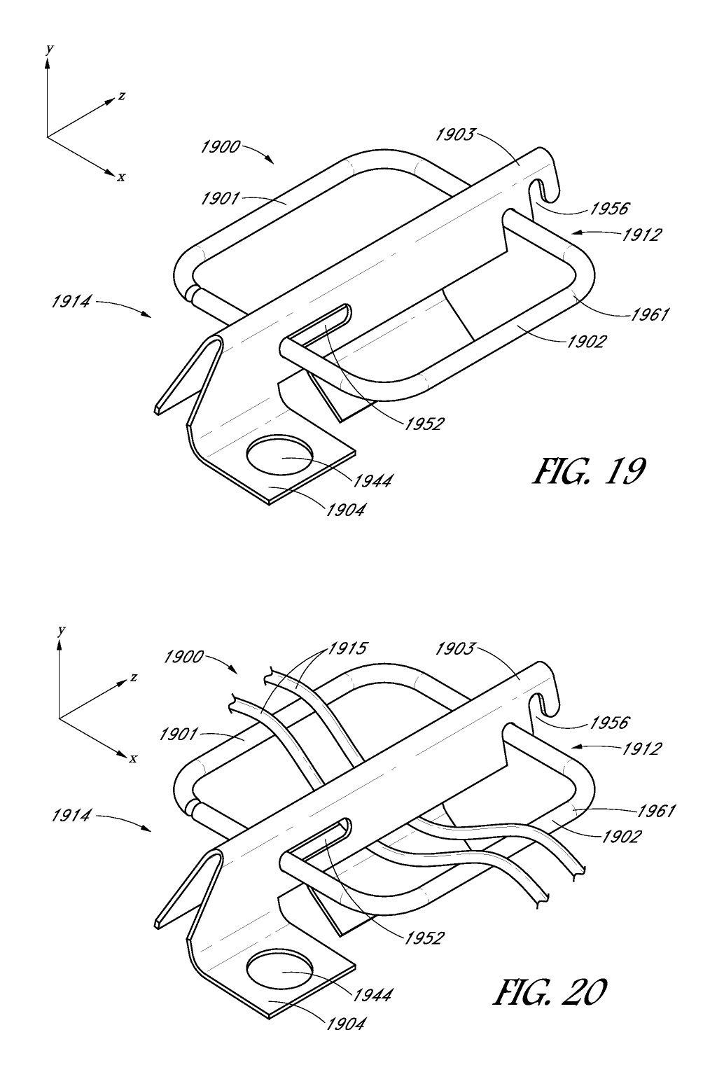

FIGS. 14-18 illustrate a cable management device 1400 in accordance with another embodiment of the disclosure. FIG. 14 is a dimetric view of the cable management device 1400. FIG. 15 is a dimetric view of the cable management device 1400 constraining a plurality of cables along their axes. FIG. 16 is a top view of the cable management device 1400, and FIGS. 17 and 18 are side views of the cable management device 1400. FIG. 17 is a side view of the cable management device 1400 as viewed from side A (see FIG. 16). FIG. 18 is a side view of the cable management device of 1400 as viewed from side B (see FIG. 16).

Turning to FIG. 14, similar to the device 100 of FIG. 1, the cable management device 1400 includes three cable support members 1401, 1402, and 1403 coupled together and extending in a substantially same direction (along the z-axis in the example illustrated in FIG. 14). The cable management device 1400 also includes a support member (e.g., a spine) 1404 coupled with each of the three cable support members 1401, 1402, and 1403 at one end 1414. The three cable support members 1401, 1402, and 1403 are separate or “open” at the opposite end 1412. The support member 1404 includes openings (e.g., holes) 1444 to facilitate coupling with a support structure. The three cable support members 1401, 1402, and 1403 include two outer members 1401 and 1402 and an inner member 1403 between the two outer members 1401 and 1402. At least the two outer members 1401 and 1402 each have a “top” surface 1405 (see FIG. 17) in the same plane. In the example illustrated in FIG. 14, the inner member 1403 has a “bottom” surface 1407 (see FIG. 17) in the same plane as the top surfaces 1405 of the two outer members 1401 and 1402.

In the illustrated embodiment, each of the three cable support members 1401, 1402, 1403 is shaped like a rounded sheet of rigid material, such as a rounded or bent sheet metal section. For example, in one embodiment, each of the three cable support members 1401, 1402, 1403 includes a section of sheet metal with rounded edges 1445 along the sides extending away from the support member 1404. The edges of the cable support members 1401, 1402, and 1403 may be rounded, similar to the edges 938 of FIG. 9 described above. For example, in one embodiment, the edges of the outer members are bent in a first direction (e.g., down), and the edges of the inner member are bent in a second direction (e.g., up) that is different from the first direction. Thus, the edges of the cable support members are bent away from the cables 1415 constrained in the device 1400. In one embodiment, the cable support members 1401, 1402, and 1403 are coupled with the support member 1404 at a substantially perpendicular angle. In the embodiment illustrated in FIG. 14, the cable support members 1401, 1402, and 1403 further include raised features or protrusions 1450, which may further facilitate retention of the cables 1415 by preventing the cables 1415 from sliding out of the device 1400 in the event that the cables 1415 experience some movement. The different configurations described above with respect to the device 100 of FIG. 1 may also apply to the device 1400 of FIG. 14. For example, the inner member 1403 may be offset from the two outer members 1401 and 1402.

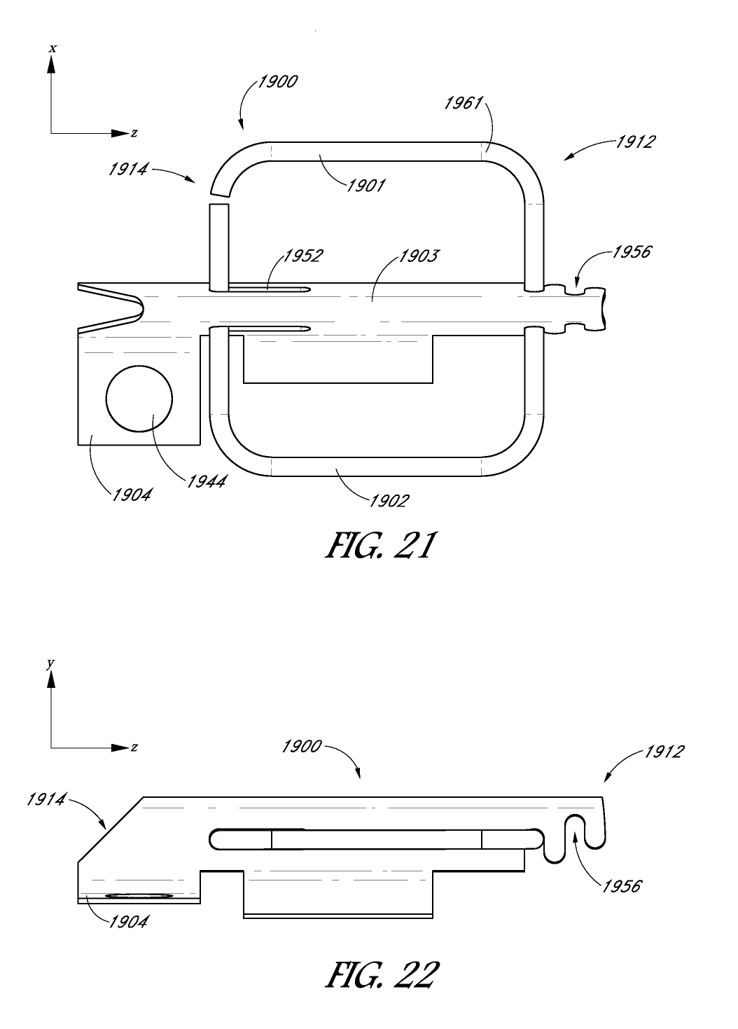

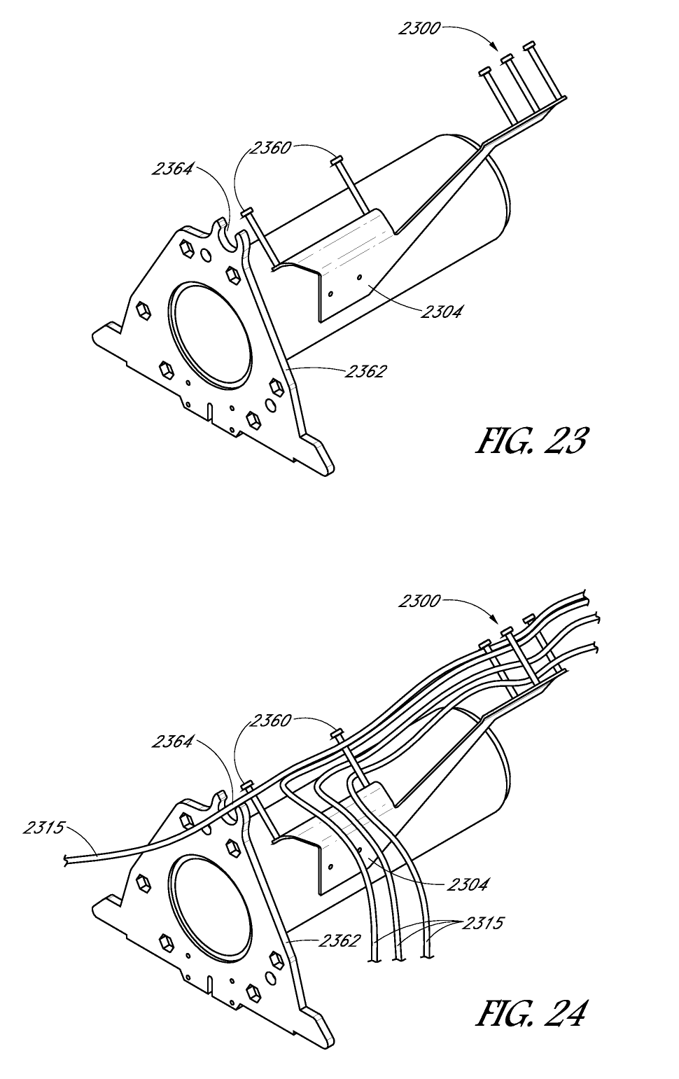

FIGS. 19-22 illustrate another embodiment of a cable management device 1900, in accordance with an embodiment of the present disclosure. FIG. 19 is a dimetric view of the cable management device 1900. FIG. 20 is a dimetric view of the cable management device 1900. FIG. 21 is a top view of the cable management device 1900, and FIG. 22 is a side view of the cable management device 1900.

Turning to FIG. 19, similar to the device 100 of FIG. 1, the cable management device 1900 includes three cable support members 1901, 1902, and 1903 coupled together and extending in a substantially same direction (along the z-axis in the example illustrated in FIG. 19). The three cable support members 1901, 1902, and 1903 include two outer members 1901 and 1902 and an inner member 1903 between the two outer members 1901 and 1902. At least the two outer members 1901 and 1902 each have a surface in the same plane. Note that the FIGS. 19-22 are illustrated from a different perspective than the previous Figures, such that the cables 1915 appear to pass “under” the outer members 1901 and 1902 and “over” the inner member 1903. However, as mentioned above, terms such as “over” and “under” are intended to convey relative positions rather than absolute positions. Thus, when viewed from the opposite side, it can be said that the cables 1915 pass over the outer members and under the inner member, like the description of other embodiments above.

In the embodiment illustrated in FIG. 19, the two outer members 1901 and 1902 are formed from two sections of a bent wire loop 1961. The bent wire loop 1961 is formed from a single bent metal wire. According to one embodiment, the bent wire loop 1961 may not be a completely closed loop (e.g., the ends may not be welded together or otherwise closed); however, in one embodiment, it may be beneficial for the ends of the bent wire loop 1961 to be either closed, or sufficiently close to one another so that the resulting gap between the ends of the wire does not interfere with the robustness of the device 1900. In the illustrated example, the bent wire loop 1961 is formed from a wire with a round cross-section. The bent wire loop 1961 is in the shape of a rectangle with rounded corners, and the two sections of the wire loop 1961 that form the outer members 1901 and 1902 are substantially parallel to each other. However, other embodiments may include different shapes, configurations, or materials. For example, the loop 1961 may be formed from another material, such as molded plastic.

The inner member 1903 is rotatably coupled with a section of the bent wire loop 1961 at one end 1914 between the two outer members 1901 and 1902. For example, the inner member 1903 includes an opening 1952 sized to receive a section of the bent wire loop 1961 to enable the inner member 1903 to rotate around the bent wire loop section to be in an “open position” or “closed position,” discussed in more detail below. The opening 1952 may be, for example, a hole (e.g., a round hole), a slot, or other opening enabling the inner member 1903 to rotatably couple with the bent wire loop 1961. The inner member also includes one or more notches 1956 at the opposite end 1912. The notches 1956 are sized to receive a section of the bent wire loop 1961.

In one embodiment, the inner member 1903 includes a slot 1952 to slidably receive the section of the bent wire loop 1961. The slot enables the inner member 1903 to slide along the z-direction, thus enabling engagement of different notches 1956 in the inner member 1903. In one such example, the inner member 1903 has different positions relative to the outer members 1901 and 1902 when the section of the bent wire loop 1961 is engaged with the different notches 1956. For example, engagement with one of the notches 1956 may allow the inner member to sit “lower” (e.g., in a plane that is closer to the plane of the outer members 1901 and 1902). Conversely, engagement with another one of the notches 1956 may enable the inner member 1903 to sit “higher up” (e.g., in a plane that is further from the plane of the outer members 1901 and 1902).

As mentioned above, the device 1900 may be in an “open position” or “closed position.” In an “open position,” the inner member 1903 at the end 1912 is rotated up and away from the bent wire loop 1961 to form an opening or gap between the end of the inner member 1903 and the closed wire loop 1961. Cables 1915 may be easily inserted into the device 1900 (e.g., as illustrated in FIG. 20). The inner member 1903 may then be moved into a closed position (e.g., rotated down and towards the bent wire loop 1961). In a “closed position,” the inner member 1903 at the end 1912 is in contact (e.g., direct contact) with the bent wire loop 1961 via engagement with one of the notches 1956, according to one embodiment. In FIG. 19, the inner member 1903 is in a closed position. When the cables 1915 are routed through the device 1900 in the closed position, the force exerted from the cables 1915 keeps the notch 1956 of the inner member 1903 engaged with the bent wire loop 1961 and substantially limits movement of the cables 1915.

In the illustrated embodiment, the inner member includes a coupling feature 1904 with an opening 1944 for coupling to a support structure. Other embodiments may not include a coupling feature, or may include different features for coupling with a support structure.

Thus, FIGS. 19-22 illustrate another example of a cable management device 1900 that can constrain cables along their axes without cutting into the cables. The device 1900 has features enabling flexibility in the diameter of cables that can be restrained, and also has the benefit of being constructed from two pieces and does not require small holes or other fine features.

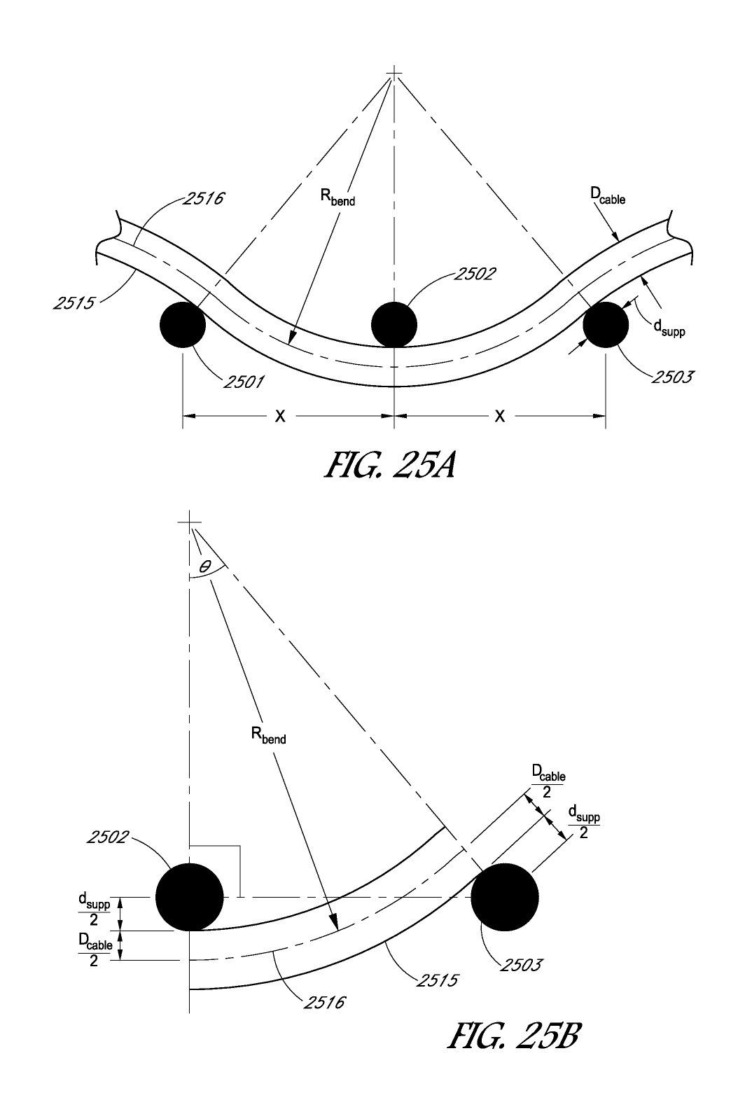

FIG. 23 is a dimetric view of a system including a portion 2362 of a PV module support including a cable management device 2300, in accordance with an embodiment of the present disclosure. FIG. 24 is a dimetric view of the system of claim 23 including a plurality of cables constrained in the cable management device 2300.

The portion 2362 of a PV module support illustrated in FIG. 23 includes features to receive and route cables from one or more PV modules supported by the PV module support over an installation surface. The portion 2362 of a PV module support may be metal and/or another material sufficient to support the cables 2315. In one embodiment, the portion 2362 of the PV module support may be referred to as a “weldment,” referring to several metal pieces welded together to form a support structure. In an embodiment where the cable management device is coupled with a weldment or other metal support structure, the whole structure may be galvanized (e.g., via hot dip galvanization). In one such embodiment, hot dip galvanizing the structure with the cable support members vertical may be beneficial to avoid lines of drips across the cable support members.

The cable management device 2300 illustrated in FIG. 23 may be the same or similar to the device 100 of FIG. 1. However, any of the cable management apparatuses described herein may be included alone or in combination in a system. The cable management device 2300 includes three cable support members are coupled with and extend away from a support member 2304. The cable support members in the example of FIG. 23 include three pins coupled with and extending from the solar module support 2304 in substantially the same direction. The pins are spaced to constrain the cables 2315 at three points along an axis of the cable. The support member 2304 is illustrated as a separate metal piece that is welded to the support structure 2362. However, in other embodiments, the three cable support members may be coupled with the support structure directly. In the illustrated embodiment, the three cable support members are pins that are welded to the support member 2304, and thus to the support structure 2362.

FIGS. 23 and 24 further illustrate a system with additional cable support members 2360. In the illustrated embodiment, two additional pins 2360 are welded to the support member 2304. As can be seen from FIG. 24, the cable support members 2360 aid in routing the cables 2315 in an orderly fashion through the opening 2364 to the device 2300, although are not spaced to prevent substantial movement of the cables 2315. In other embodiments, one or more additional cable support members may be spaced to further prevent cable movement. For example, an additional cable support member may be located and spaced similarly to the three cable support members of the device 2300 (e.g., four equally spaced cable support members) to constrain the cables 2315 along their axes. In another embodiment, a system may include multiple cable management devices at different locations along the cables. Furthermore, although the above description refers to welding the cable management device 2300 onto a support structure, other embodiments may include other means of coupling a cable management device with a support structure, such as with a fastener (e.g., bolt or other fastener), adhesive, or other bonding technique. Thus, a cable management device may be permanently or releasably coupled with a support structure. In yet another embodiment, the cable management device may be a “floating” device that is not be attached to a support structure.

Constraining the cables enable the support structure 2362 to move without causing the cables constrained in the device 2300 to move. Thus, in a system such as a tracking PV system that involves movement throughout the day, the cables 2315 are held in place, which limits wear on the cables and can prevent other problems described above associated with moving cables. Although FIGS. 23 and 24 illustrate a portion of a PV system in which a cable management device may be used, as discussed above, in addition to the solar power field, cable management devices may be used in a many different fields.

Thus, cable management devices and systems have been disclosed. Embodiments provide a cable management solution that can hold one or more cables without cutting into and damaging the cables. Constraining cables with a cable management device can result in a more robust and secure solution, which may be beneficial in applications with moving parts. Embodiments may be easily scaled to accommodate a variety of cable sizes and shapes. Additionally, embodiments described herein can be manufactured into a piece of sheet metal or other support that is already being used for another structural or mechanical purpose. Therefore, embodiments may not require any tools for assembly or disassembly. Furthermore, some embodiments lack small holes or delicate features that can be bent or filled up during the galvanization process.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

1. An apparatus for cable management, the apparatus comprising:
three cable support members coupled together and extending in a substantially same direction, the three cable support members comprising two outer members and an inner member between the two outer members;
wherein at least the two outer members each have a surface along their length substantially in a same plane; and
wherein the three cable support members are spaced to constrain a cable disposed over the surface of the two outer members and under the inner member.

2. The apparatus of claim 1, wherein the three cable support members are spaced to constrain the cable at three or more points along an axis of the cable.

3. The apparatus of claim 1, wherein the three cable support members are equally spaced.

4. The apparatus of claim 3, wherein the three cable support members comprise cylinders each having an axis substantially in a same second plane.

5. The apparatus of claim 4, wherein the three cable support members comprise cylindrical pins.

6. The apparatus of claim 5, wherein each of the cylindrical pins are separated at one end, and coupled together at an opposite end.

7. The apparatus of claim 1, wherein the three cable support members comprise sections of a stiff bent wire, the wire having a round cross-section.

8. The apparatus of claim 7, wherein the inner member comprises a section of the wire bent into two substantially parallel sections, wherein each of the two substantially parallel sections comprises a support point to constrain the cable along its axis.

9. The apparatus of claim 8, wherein the inner member further comprises a bend between and at one end of the two substantially parallel sections, and wherein the bend is further bent towards the cable.

10. The apparatus of claim 1, wherein each of the three cable support members comprise sheet metal sections, wherein edges of the sheet metal sections are rounded.

11. The apparatus of claim 10, further comprising:
a first sheet metal section coupled with a first end of each of the three cable support members, wherein the inner support member is coupled with the first sheet metal section via a hinge; and
a second sheet metal section coupled with a second end of each of the two outer members, wherein the second sheet metal section comprises a latch to couple a second end of the inner member with the second sheet metal section.

12. A system comprising:
a photovoltaic (PV) module support to support one or more PV modules over an installation surface; and
a cable management apparatus coupled with the PV module support, the cable management apparatus comprising:
three cable support members coupled together and extending in substantially the same direction, the three cable support members comprising two outer members and an inner member between the two outer members;
wherein at least the two outer members each have a surface along their length in substantially the same plane; and
wherein the three cable support members are spaced to constrain a cable disposed over the surface of the two outer members and under the inner member.

13. The system of claim 12, wherein the three cable support members are spaced to constrain the cable along at three points along an axis of the cable.

14. The system of claim 12, wherein the three cable support members extend away from the PV module support.

15. The system of claim 12, wherein the PV module support comprises a weldment to support the one or more PV modules over the installation surface.

16. The system of claim 15, wherein the three cable support members comprise pins welded to the weldment.

17. The system of claim 16, wherein the pins each having an axis substantially in a same second plane.

18. A system comprising:
a photovoltaic (PV) module support to support one or more PV modules over an installation surface; and
three pins coupled with and extending from the solar module support in a substantially same direction, the three pins comprising two outer pins and a middle pin between the two outer pins;
wherein the three pins are spaced to constrain a cable disposed over the two outer pins and under the middle pin.

19. The system of claim 18, wherein the pins are spaced to constrain the cable along at three points along an axis of the cable.

20. The system of claim 19, wherein the pins each have an axis substantially in a same plane.

21.-29. (canceled)
